(19) United States
(12) Patent Application Publication
(10) Pub. No.: US 2005/0081677 A1
(43) Pub. Date: Apr. 21, 2005

(54) Handle vibration dampening

(76) Inventors: Kenneth A. Pingel, Hillsboro, OR (US); Donald F. Misho, Portland, OR (US)

Correspondence Address: DELLETT AND WALTERS, P. O. BOX 2786, PORTLAND, OR, 97208-2786, US

(21) Appl. No.: 10/966,135

(22) Filed: Oct. 15, 2004

Related U.S. Application Data
(60) Provisional application No. 60/511,847, filed on Oct. 15, 2003.

(51) Int. Cl. B62K 21/12

(52) U.S. Cl. 74/551.1

(57) ABSTRACT

Vibration dampening in a handle is accomplished by employing a relatively soft tube which is inserted into the interior hollow of the handle. A harder interior is provided to the tube and the interaction therebetween results in vibration dampening.

### BACKGROUND OF THE INVENTION

This invention relates to handle vibration dampening for handlebars or the like.

Vibration in motorcycle handlebars, for example, can lead to fatigue for the rider after a long time riding, and over time, can result in nerve damage.

A typical handlebar is shown in FIG. 1, where the handlebar 10 is a hollow tubular member formed to a certain shape. A typical prior art type dampening bar 12 is added to attempt to control some of the vibration.

### SUMMARY OF THE INVENTION

In accordance with the invention, an insert is provided which is placed inside the hollow tube of the handle. The insert is typically tubular, and comprises a softer outer layer and a harder inner core.

Accordingly, it is an object of the present invention to provide an improved handlebar vibration dampening method and apparatus

It is a further object of the present invention to provide an improved manner of reducing the vibration in a handlebar to reduce rider fatigue.

It is yet another object of the present invention to provide an improved system for modifying handlebars to reduce vibration.

A further object of the invention is to provide improved vibration reduction for handles in environments prone to vibration.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a view of a typical prior art handlebar and vibration dampening bar;

FIG. 2 is a view of a handlebar to illustrate placement of the insert therein; and

FIG. 3 is a view of a cross section of a handlebar with the dampening device in accordance with the invention installed therein.

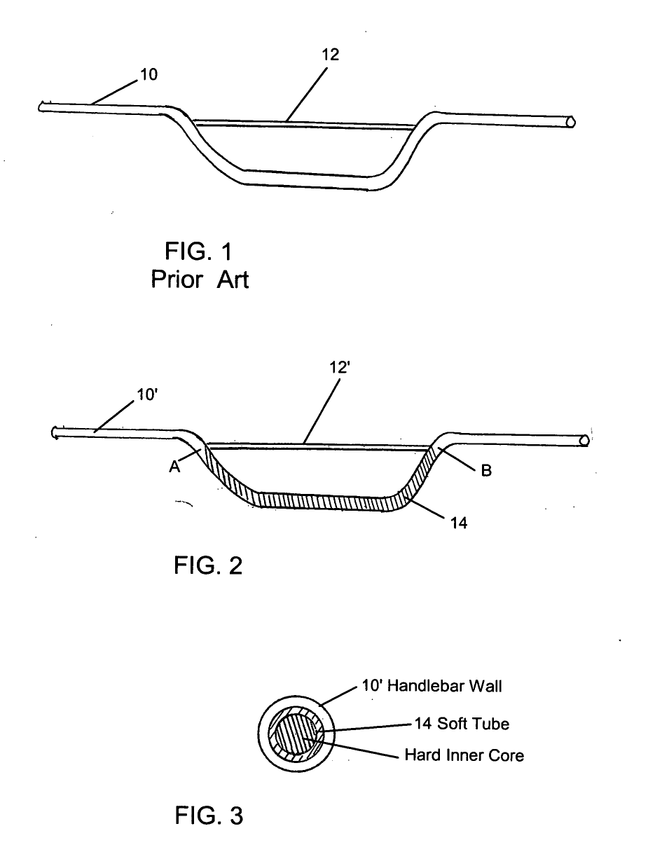

### DETAILED DESCRIPTION

The system according to a preferred embodiment of the present invention comprises providing an insert which is placed inside the hollow tube of the handle or handlebar. The insert is typically tubular, and comprises a softer outer layer and a harder inner core. It is believed that the differences in hardness of the layers going from the handlebar wall, the outer layer and the inner layer results in a dampening effect.

Referring to FIG. 2, the invention involves inserting a soft tube 14 into the handlebar 10′, desirably to span between the points A and B of the handlebar at least, or more. Then, a harder inner core is provided to the inserted tube, suitably by injecting polyurethane into the hollow core of the inserted tube. The polyurethane then hardens after a curing period, and the result is a substantial dampening effect. The injecting can be accomplished by use of a syringe, for example. Accordingly, the invention can be provided as a kit for after market installation on handlebars by an end user or by an authorized installation agent or mechanic, or can be accomplished in a manufacturing setting to produce handlebars with the invention installed therein at the factory.

FIG. 3 shows a cross section of a handlebar 10′ with the inserted dampening device. The soft tube suitably touches the wall of the handlebar in the preferred embodiment, but is not tight.

The invention pertains to both the resulting device and the method or process and service of installing the tube and then injecting the center core as a liquid and allowing it to cure.

An example material for the soft outer tube is a silicon hose having 40A durometer hardness, while the inner core is polyurethane having 60 short D durometer hardness.

The dampening effect provided is quite pronounced and noticeable. While the particular example of use is motorcycle handlebars, the invention can find use in other situations, such as in handles for powered machinery or other vibrational environments where a grippable handle or member is provided that is transmitting undesirable vibration to a user or operator.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A handlebar comprising:
an outer handlebar shell; and
an inner member within the outer handlebar shell, comprising a polymer.

2. The handlebar according to claim 1, wherein said inner member comprises a first polymer and a second polymer.

3. The handlebar according to claim 2, wherein said first polymer is soft.

4. The handlebar according to claim 3, wherein said first polymer has approximately a 40A durometer hardness.

5. The handlebar according to claim 2, wherein said second polymer is hard.

6. The handlebar according to claim 5, wherein said second polymer has approximately a 60 short D durometer hardness.

7. The handlebar according to claim 2, wherein said first polymer substantially surrounds said second polymer.

8. A handlebar vibration dampening device, comprising:
an elongate member adapted for insertion into an interior of a handlebar, said elongate member comprising a first outer portion and a second inner portion.

9. The handlebar vibration dampening device according to claim 8, wherein said first outer portion comprises a polymer.

10. The handlebar vibration dampening device according to claim 9, wherein said polymer is a substantially soft polymer.

11. The handlebar vibration dampening device according to claim 10, wherein said polymer has approximately a 40A durometer hardness.

12. The handlebar vibration dampening device according to claim 8, wherein said second inner portion comprises a polymer.

13. The handlebar vibration dampening device according to claim 12, wherein said polymer is a substantially hard polymer.

14. The handlebar vibration dampening device according to claim 13, wherein said second polymer has approximately a 60 short D durometer hardness.

15. The handlebar vibration dampening device according to claim 8, wherein said first portion substantially surrounds said second portion.

16. A method for providing vibration dampening to a handle, wherein said handle has at least a partially interior void therein, comprising the steps of:
inserting a first polymer into the interior void; and
inserting a second polymer into the first polymer.

17. The method according to claim 17, wherein said first polymer comprises a tube and said step of inserting a second polymer comprises injecting said second polymer into said tube and allowing said second polymer to cure to a hardness.

18. The method according to claim 17, wherein said hardness of said second polymer when cured is greater than a hardness of said first polymer.
